(19) United States
(12) Patent Application Publication
(10) Pub. No.: US 2012/0219939 A1
(43) Pub. Date: Aug. 30, 2012

(54) TRAINING DEVICE, METHOD AND TRAINING SYSTEM

(75) Inventors: Hiroyuki Aikawa, Shizuoka-ken (JP); Masanori Sambe, Shizuoka-ken (JP); Takesi Kawaguti, Shizuoka-ken (JP)

(73) Assignee: TOSHIBA TEC KABUSHIKI KAISHA, Tokyo (JP)

(21) Appl. No.: 13/372,614

(22) Filed: Feb. 14, 2012

(30) Foreign Application Priority Data
Feb. 25, 2011 (JP) 2011-040819

(51) Int. Cl. G09B 25/00

(52) U.S. Cl. 434/379

(57) ABSTRACT

A training device comprising an operation record storage unit configured to store an image simulating a user interface for inputting the operation to an input device for accepting an inputting of commodity with an operation information which is input to a user interface according to the continuous display of a dynamic image which is represented an opportunity phenomenaa as the opportunity of the operation or a still images in a memory unit and a regeneration unit configured to regenerate a operation condition based on the operation information of an operator and stored by the operation record storage unit by identification marking a matched part of the image simulating a user interface. By using the training device, the training progress can be confirmed.

### CROSS-REFERENCE TO RELATED APPLICATION

This application is based upon and claims the benefit of priority from Japanese Patent Application No. 2011-040819, filed Feb. 25, 2011, the entire contents of which are incorporated herein by reference.

### FIELD

Embodiments described herein relates to a training device, a method and a training system.

### BACKGROUND

A processing device executes the processing relevant to various services of menu items such as an order accepting service or a settlement service and the like in most restaurants such as a family restaurant or a wine house, etc.

Furthermore, the processing device inputs the operation of a user such as a shop assistant and the like by an input device and executes the processing which corresponds to the input of user.

Specifically, in the case of a system which is used in the restaurant, the input device and the processing device are respectively to be an order terminal and a base station (a server) for instance. Furthermore, the operation which appoints the menu items ordered by a customer is input in the order terminal at present. The order terminal generates order accepting information which includes a list of the ordered menu items according to the input operation and transmits the order accepting information to the base station. The base station generates a cooking instructing slip or manages the sales and the like according to the order accepting information.

### BRIEF DESCRIPTION OF THE DRAWINGS

FIG. 1 is a structural diagram of an order processing system according to an embodiment;

FIG. 2 is a block diagram illustrating the hardware structure of an information terminal;

FIG. 3 is a diagram modularly illustrating an example of a training course database;

FIG. 4 is a diagram modularly illustrating an example of a training condition database;

FIG. 5 is a diagram illustrating an example of the information recorded in a standard operation setting file;

FIG. 6 is a flowchart of a training processing process;

FIG. 7 is a front view illustrating an example of a display screen containing a course selection image;

FIG. 8 is a front view illustrating an example of a display screen containing a training image;

FIG. 9 is a front view illustrating an example of a display screen containing a re-displayed course selection image;

FIG. 10 is a front view illustrating an example of a display screen containing a training result list;

FIG. 11 is a functional block diagram illustrating the functional structure for a training confirming processing;

FIG. 12 is a flow chart of a training confirming process;

FIG. 13 is a front view illustrating an example of a display screen containing a regenerated training image;

FIG. 14 is a front view illustrating an example of a display screen containing a regenerated training image;

FIG. 15 is a front view illustrating an example of a display screen containing a regenerated training image;

FIG. 16 is a diagram illustrating the structure of a training system using a cloud system.

### DETAILED DESCRIPTION

According to one embodiment, a training device, comprising a display unit configured to display an image simulating a user interface for inputting the operation to an input device, and a dynamic image or a still images displayed continuously which is represented an opportunity phenomena as the opportunity of the operation on one display, an operation record storage unit configured to store an operation information which is input to the image simulating the user interface displayed on the display unit in a memory unit and a regeneration unit configured to display the operation information stored by the operation record storage unit on the display unit.

According to one embodiment, a method, comprising displaying an image simulating a user interface for inputting the operation to an input device, and a dynamic image or a still images displayed continuously which is represented an opportunity phenomena as the opportunity of the operation on one display, storing an operation information which is input to the image simulating the user interface displayed on the display unit in a memory unit and displaying the operation information stored by the operation record storage unit on the display unit.

According to one embodiment, a training system contains at least one server device and at least one terminal device, comprising a display unit configured to display an image simulating a user interface for inputting the operation to an input device, and a dynamic image or a still images displayed continuously which is represented an opportunity phenomena as the opportunity of the operation on one display, an operation record storage unit configured to store an operation information which is input to the image simulating the user interface displayed on the display unit in a memory unit and a regeneration unit configured to display the operation information stored by the operation record storage unit on the display unit, wherein the server device comprises at least one of the operation record storage unit and the regeneration unit and the terminal device comprises either the operation record storage unit or the regeneration unit which is not include in the server device.

An example of the embodiment is described below with reference to accompanying drawings.

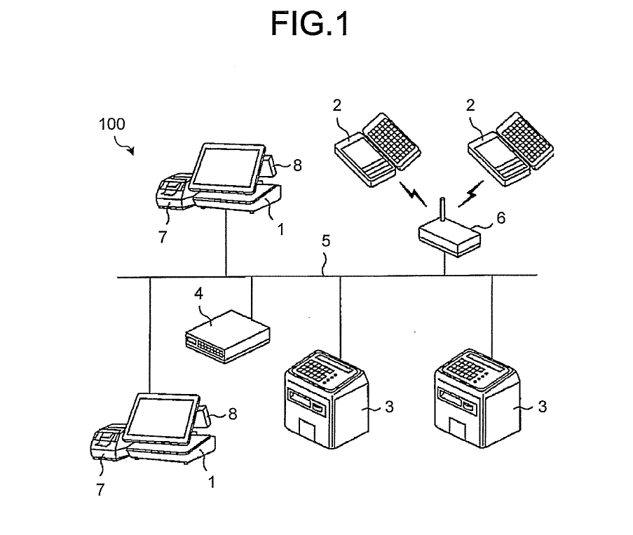

FIG. 1 is a structure diagram of an order processing system 100 related to the embodiment.

The order processing system 100 can be used in various facilities where the food service or the commodity sales service is provided according to an order of the customer in many places such as the restaurant or the shop, etc. However, the order processing system 100 which is used in the restaurant is illustrated.

The order processing system 100 connects a plurality of information terminals 1, a plurality of handheld terminals 2, a plurality of slip printers 3 and a base station 4 to an LAN (Local Area Network) 5 respectively. However, the handheld terminals 2 are connected with the LAN 5 by a plurality of wireless access points 6. The number of the information terminals 1, the handheld terminals 2 and the slip printers 3 can be respectively to be two at random as shown in FIG. 1. The number of the information terminals 1, the handheld terminals 2 and the slip printers 3 also can be one.

The information terminals are disposed at a customer service floor or a checkout counter for instance to process various services for the customer such as the guidance service, the ordering service, the assistant (set on the table) service or the settlement service, etc. Furthermore, the information terminals 1 which are disposed in the customer service floor are mainly used for processing the guidance service, the ordering service and the assistant (set on the table) service. Furthermore, the information terminals 1 which are disposed in the checkout counter are mainly used for processing the settlement service. In addition, the information terminals 1 also can be used for special purposes only by means of the processing which is relevant to some services.

Furthermore, at least one of the information terminals 1 has a training function capable of training the operation in the handheld terminals 2 to be used as a training device.

Each handheld terminal 2 comprises a user interface which is used for arranging a plurality of operational keys such as a plurality of soft key or a plurality of hard keys and the like. Each handheld terminal 2 is used as the input device which is used for inputting the user operation for inputting the order by the user interface. Each handheld terminal 2 generates order information according to the input operation and wirelessly transmits the order information. The order information witlessly transmitted by each handheld terminal 2 is transmitted to the base station 4 by the wireless access points 6 and the LAN 5.

The slip printers 3 are disposed at the customer service floor or a kitchen for instance. The slip printers 3 which are disposed at the customer service floor are used for printing an order slip based on the order information for the customer, i.e. the slip printers 3 which are disposed at the customer service floor are used as the so-called customer printers. Furthermore, the slip printers 3 which are disposed at the kitchen are used for printing a cooking instructing slip based on the order information for the cooker, i.e. the slip printers 3 which are disposed at the kitchen are used as the so-called kitchen printers.

The base station 4 is disposed at a back-yard for instance to accumulate all kinds of information transmitted by the information terminals 1 and process the management service relevant to the business of the restaurant. The base station 4 is further used for managing the information shared by the information terminals 1.

In general, in the order processing system 100, the order information which is generated in the information terminals 1 or the handheld terminals 2 according to the operation of the user is transmitted to the base station 4 from the LAN 5 when the user inputs the order by the information terminals 1 or the handheld terminals 2. The base station 4 is used managing the transmitted order information such as the settlement or the accumulation, etc. Furthermore, the base station 4 is used for transmitting the order information to the slip printers 3 via the LAN 5. The slip printers 3 are used for printing the cooling instructing slip or the order slip which corresponds to the content of the transmitted order information.

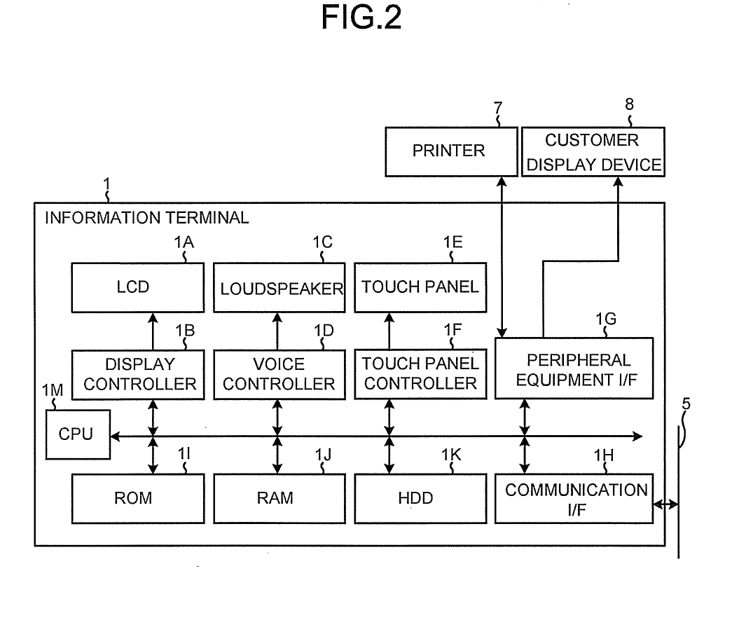

The information terminal 1 is described below in detail. Here, FIG. 2 is a block diagram showing the structure of each information terminal 1.

As shown in FIG. 2, each information terminal 1 comprises an LCD 1a, a display controller 1b, a loudspeaker 1c, a voice controller 1d, a touch panel 1e, a touch panel controller 1f, a peripheral equipment interface (peripheral equipment I/F) 1g, a communication interface (communication I/F) 1h, a ROM (read only memory) 1i, a memory unit RAM (random access memory) 1j, a memory unit HDD (hard disk drive) 1k and a CPU (central processing unit) 1m.

Wherein the display controller 1b, the voice controller 1d, the touch panel controller 1f, the peripheral equipment interface 1g, the communication interface 1h, the ROM 1i, the RAM 1j, the HDD 1k and the CPU 1m are respectively connected with a bus line. The LCD 1a, the loudspeaker 1c and the touch panel 1e are respectively connected with the display controller 1b, the voice controller ld and the touch panel controller 1f.

The display controller 1b drives the LCD 1a to display the image which corresponds to the image data transmitted under the control of the CPU 1m. The LCD 1a is driven by the display controller 1b to display an image.

The voice controller 1d drives the loudspeaker 1c to regenerate the voice which corresponds to the voice data transmitted under the control of the CPU 1m. The loudspeaker 1c regenerates the voice driven by the voice controller 1d.

The touch panel 1e is disposed on a display surface of the LCD 1a in a laminating way. The touch panel le outputs a detection signal which corresponds to a touch position of the user when the user touches a display picture of the LCD 1a. The touch panel controller 1f obtains coordinate information which shows the touch position according to the detection signal output by the touch panel 1e and transmits the coordinate information to the CPU 1m. The touch panel 1e is used as one of the input devices for inputting the user operation for training during training.

The peripheral equipment interface 1g is connected with the peripheral equipment such as a printer 7 or a customer display device 8 as required. The peripheral equipment interface 1g is communicated with the connected peripheral equipment. The peripheral equipment interface 1g can use an interface circuit and the like according to the general specification of a USB (universal Serial bus). Furthermore, the printer 7 is used for printing an order slip, a receipt slip, various daily papers, etc. The customer display device 8 is used for displaying the image which shows the settlement result or the advertisement information and the like to the customer. At least one of the printer 7 and the customer display device 8 further can be disposed in the information terminals 1.

The communication interface 1h is communicated with the slip printers 3 and the base station 4 by the LAN 5. The communication interface 1h can use an interface circuit and the like according to the general specification of the Ethernet network (registered trademark), etc.

The ROM 1i memorizes a program which records the processing Acts of the CPU 1m or the data for the CPU 1m to execute various processes as required, etc.

The RAM 1j memorizes the data for the CPU 1m to execute various processes as required. For example, the RAM 1j memorizes the image information showing the image displayed in the LCD 1a. Furthermore, the RAM 1j further can be used as a work region when the CPU 1m executes various processes.

The HDD 1k memorizes a program which records the processing Acts of the CPU 1m or the data for the CPU 1m to execute various processes as required, etc. The HDD 1k memorizes a database which is relevant to the menu items provided by the restaurant provided with the order processing system 100.

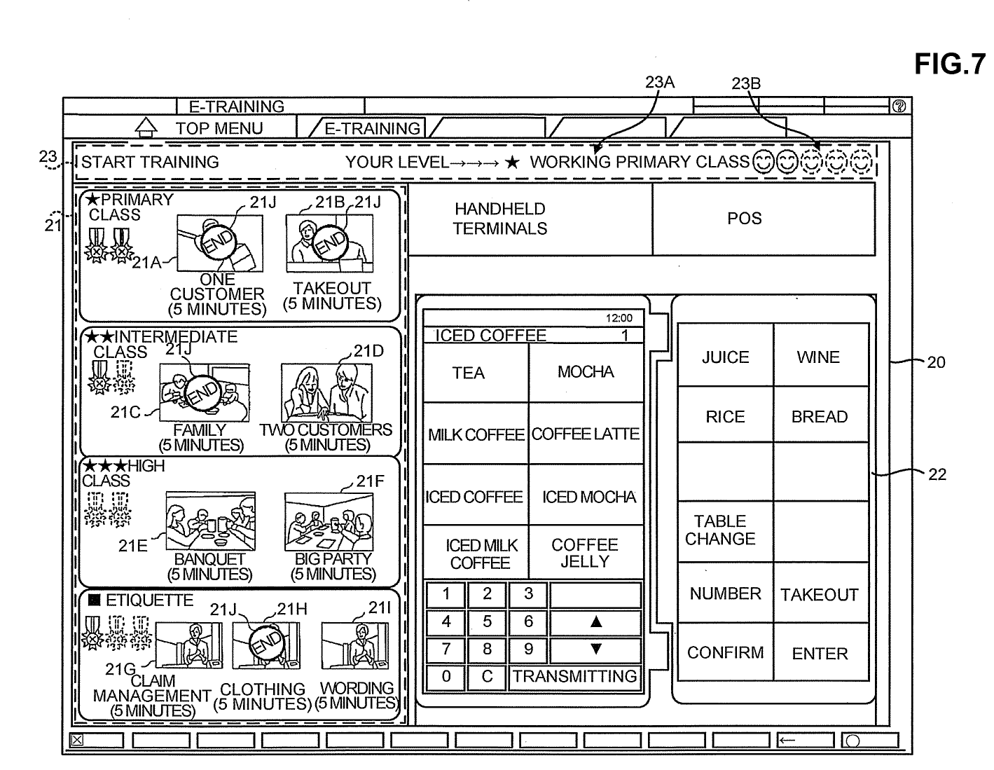

The HDD 1k stores the data of the input interface image 22 (referring to FIG. 7) simulating the user interface of the hand-hold terminal 2 as the data that is needed by the CPU 1m to execute various processing and will be described later in detail.

Moreover, the HDD 1k stores a training course database, training condition database, the plurality of dynamic image files regenerated during the training processing described later and a standard operation setting file.

The CPU 1m executes, according to the program stored in the ROM 1i or the HDD 1k, various processing related to the aforementioned services or the training processing and training confirming processing that will be described later.

In addition, the information terminal 1 can be solid or transferred while programs are stored in the ROM 1i or the HDD 1k, or the state stored in the storage medium or the program sold or transferred via the communication of the communication line is optionally installed in the information terminal 1. Further, all kinds of mediums can be used as the storage medium, such as magnetic disc, magneto-optical disc, optical disc or semiconductor memory.

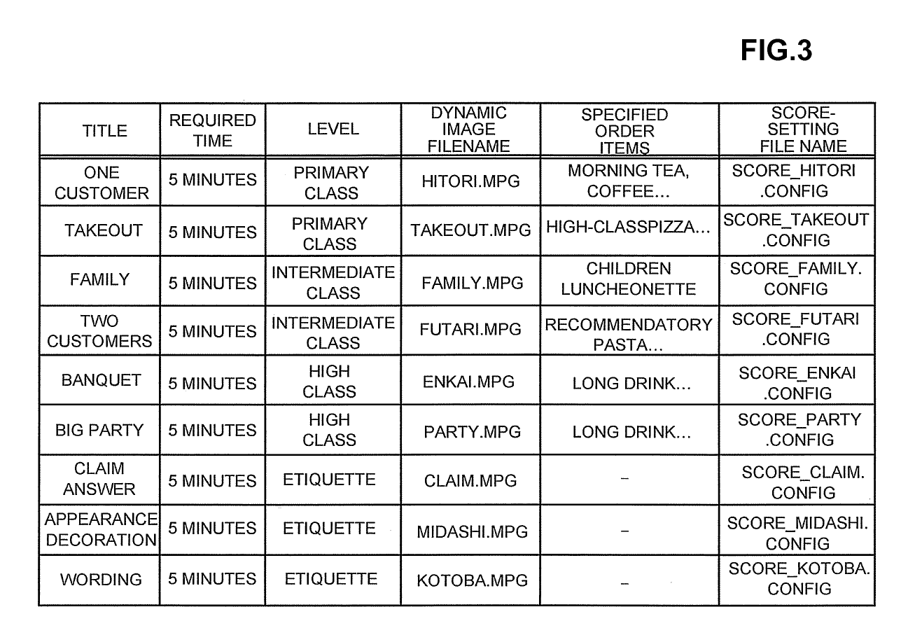

Next, the training course database stored in the HDD 1k is described below. Here, FIG. 3 is a diagram modularly illustrating an example of the training course database.

As shown in FIG. 3, the training course database contains data records, each of which is corresponding to a training course. Each data record includes information fields related to a title, a needed period, a grade, a dynamic image file name, the menu items of a specified order and a standard operation setting file name. The information recorded in the title-related information field represents a title for identifying a training course. The information recorded in the information field related to a needed period represents the time needed for a training course. The information recorded in the grade-related information field represents the degree of difficulty, etc. The information recorded in the information field related to a dynamic image file name represents the identification name of a dynamic image file to be used. The information recorded in the information field related to the menu items of a specified order represents items that should be input the menu items as a specified order. The information recorded in the information field related to a standard operation setting file name represents the identification name of a standard operation setting file recorded according to the set information containing the content of a standard operation that should be carried out by the user according to the opportunity phenomena of each training course.

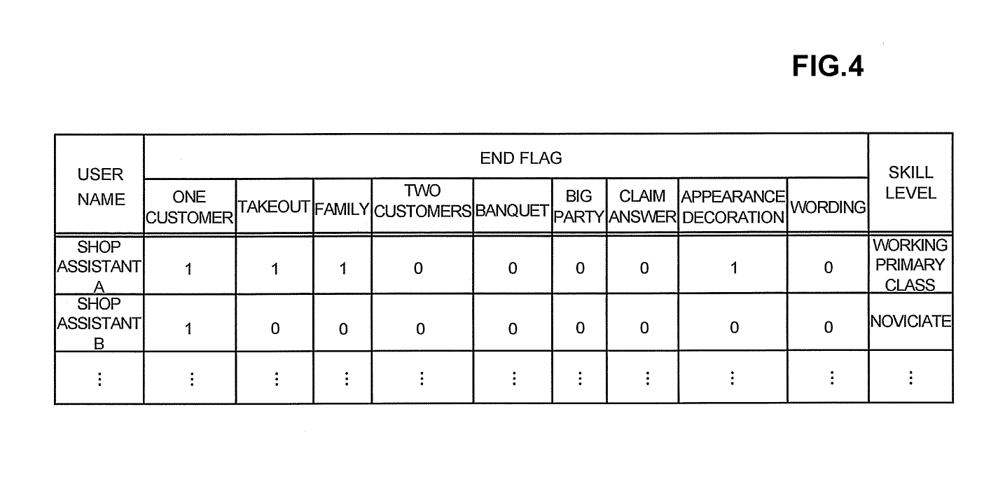

Next, the training condition database stored in the HDD 1k is described below. FIG. 4 is a diagram modularly illustrating an example of the training condition database.

As shown in FIG. 4, the training condition database contains data records, each of which records the training condition of a corresponding user (a shop assistance here). Each data record includes information fields related to a user name, a training course completion and a skill level. The information recorded in the information field related to a user name represents a name for identifying a user. The completion flag, which may be either 0 (uncompleted) or 1 (completed), represents whether or not a training course is completed. The information recorded in the information field related to a skill level represents the degree of skill level of the operator of the hand-hold terminal 2.

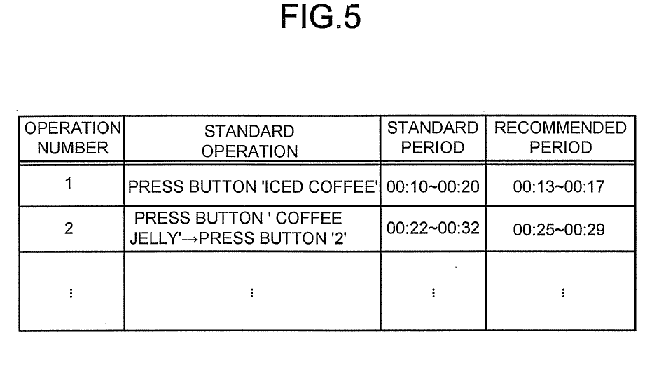

Next, the standard operation setting file database stored in the HDD 1k is described below. Here, FIG. 5 is a diagram illustrating an example of the information recorded in the standard operation setting file. The standard operation setting file corresponds to each of a plurality of training courses and records the setting information containing the content of a standard operation that should be carried out by the user according to the opportunity phenomena of each course. As shown in FIG. 5, the standard operation setting file is a set of setting information including the information related to an operation number, standard operation information, a standard period and a recommended period.

The operation number represents a number that is numbered according to the order of the timing that should be carried out these operation for the operation of the user should carry out according to an opportunity phenomena during a training process.

The standard operation represents the content of a standard operation that should be carried out by the user and is numbered with the operation number contained in the same setting information. The standard period represents a period allowed for the operation numbered with the operation number contained in the same setting information. The recommended period represents a recommended period for the operation numbered with the operation number contained in the same setting information.

The first setting information shown in FIG. 5 represents a standard operation of pressing down the button ‘iced coffee’ in the case where a dynamic image is represented by taking the action of ordering a cup of iced coffee as an opportunity phenomena, the operation of pressing down the button ‘ iced coffee’ should be carried out within the elapsed period ‘00:10’-‘00:20’, and preferably, within the elapsed period ‘00:13’-‘00:17’ of the dynamic image.

Next, the actions of the order processing system 100 are described below which are carried out according to the program stored in the ROM 1i or the HDD 1k to focus on achieving the training processing and the training confirming processing of the information terminal 1.

Generally, the user can get skill with the operation of the hand-hold terminal 2 used for an order service in a restaurant through a real service work or a simulated service work in which other shop assistants play the role of customers. On the other hand, the user desires to get skill with the operation of the hand-hold terminal 2 through the ways of other than the simulated service work in which other shop assistants play the role of customers, etc and keep skill of the operation. Therefore, the information terminal 1 displays a dynamic image for the use of an order and an operation image of the hand-hold terminal 2, operates the operation image of the hand-hold terminal 2 along the dynamic image, determines whether or not to carry out the operation along the dynamic image, and displays the result of the determination.

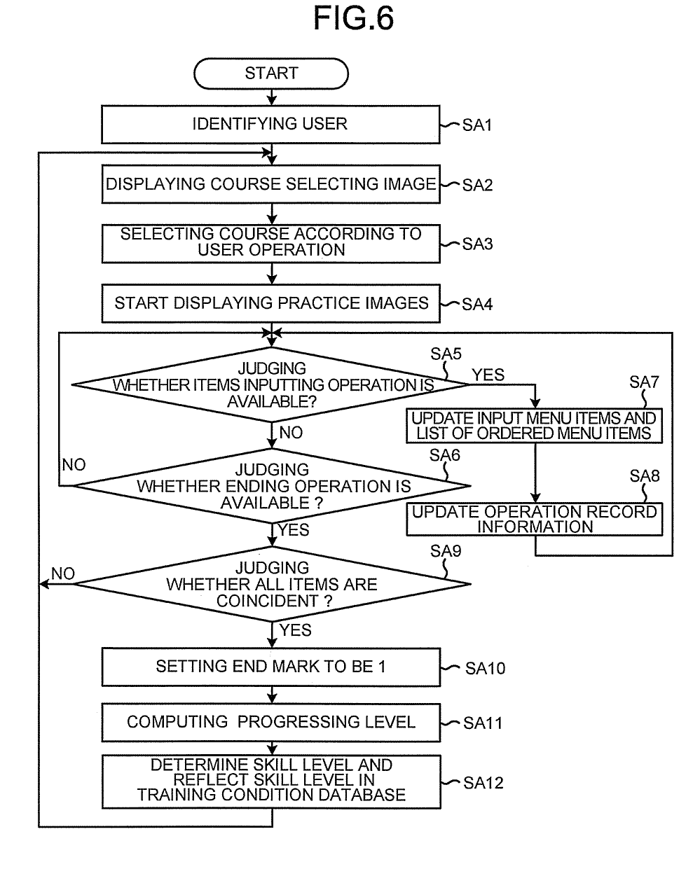

Next, when desiring to training operating the hand-hold terminal 2, the user can use the training functions provided by the information terminal 1. The CPU 1m carries out the training shown in FIG. 6 in the information terminal 1, the training function of which is required by the user to be activated.

The CPU 1m of the information terminal 1 generates a course selection image when authenticating a user (Act Sa1) and instructs the display controller 1b to display the course selection image (Act Sa2). According to the instruction, the display controller 1b drives the LCD 1a to display a matched course selection image.

Here, FIG. 7 is a front view illustrating an example of a display screen containing a course selection image 20. As shown in FIG. 7, the course selection image 20 comprises a course list image 21, an input interface image 22 and a guidance image 23.

The course list image 21 provides the general view of the training courses registered in a training course database. In the example shown in FIG. 7, the course list image 21 comprises the dynamic image thumbnails 21a, 21b, 21c, 21d, 21e, 21f, 21g, 21h and 21i of the training courses contained in the course list image 21. The course list image 21 shown below the dynamic thumbnails 21a-21i comprises the title of each training course and the text indicating the time needed for the training of each training course. Moreover, the course list image 21 shows the dynamic thumbnails 21a-21i separately in accordance with the grades of the training courses.

Moreover, the course list image 21 contains a completion flag 21j that is overlapped with the dynamic image thumbnail of a training course the completion flag of which is changed to ‘1’ in the training condition database of the user authenticated in Act Sa1 to identify the completion of a training. In the training condition database shown in FIG. 4, the training courses of a user ‘shop assistant A’, the completion flags of which are changed to ‘1’ refers to training courses ‘one customer’, ‘takeout’, ‘family’ and ‘clothing’. And accordingly, the completion flags 21j are contained In FIG. 7 that are respectively overlapped with the states of dynamic thumbnails 21a, 21b, 21c and 21h of training courses ‘one customer’, ‘takeout’, ‘family’ and ‘clothing’.

The input interface image 22 is an image which simulates in appearance the user interface of the hand-hold terminal 2. The guidance image 23 contains a string 23a representing the skill level of a user and an flag 23b.

Returning to the flow chart of FIG. 6, the CPU 1m of the information terminal 1 selects a training course (Act Sa3) according to the operation of the user. Specifically, the CPU 1m selects a training course related to the user-touched dynamic thumbnail contained in the course list image 21. For instance, if the user touches the display area of the dynamic thumbnail 21d shown in FIG. 7, then the CPU 1m selects the training course titled ‘two customers’.

Then, the CPU 1m of the information terminal 1 starts displaying a dynamic image corresponding to the selected training course (Act Sa4). If the selected is, for example, a training course titled ‘two customers’, then the CPU 1m acquires, according to the training course database, ‘Futari.mpg’ as a dynamic image file name, generates a training image containing a dynamic image that is stored in the dynamic image file in the HDD 1k and named ‘Futari.mpg’, and instructs the display controller 1b to display the training image. According to the instruction, the display controller 1b drives the LCD 1a to display a matched course image. In addition, the CPU 1m instructs the voice controller 1d to regenerate a voice corresponding to the voice data contained in the dynamic image file. According to this instruction, the voice controller 1d drives the loudspeaker 1c to regenerate a matched voice.

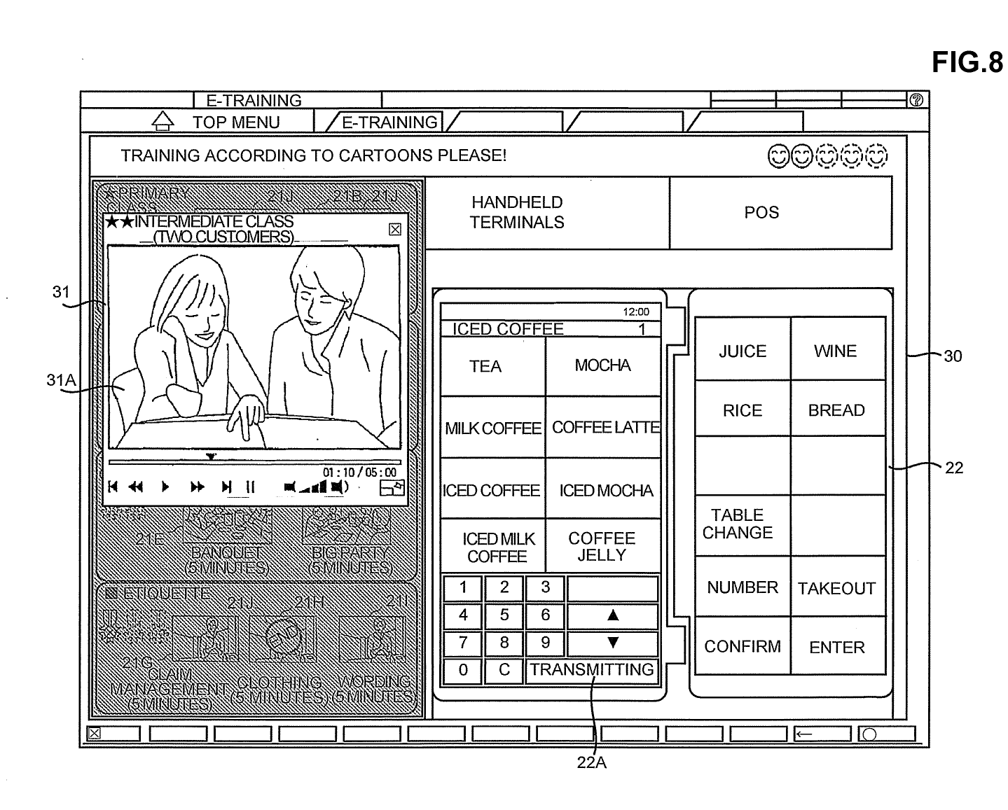

Here, FIG. 8 is a front view illustrating an example of a display screen containing a training image 30. As shown in FIG. 8, the training image 30 contains a display image 31 when the course list image 21 is overlapped with the course selection image 20. The display image 31 contains a dynamic image 31a. In addition, the CPU 1m selects, one by one, a plurality of image frames represented by dynamic image files as display objects at fixed time interval and automatically changes the image frames shown as the display objects of the dynamic image 31a. The dynamic images and the voice represented by dynamic image files represent a plurality of events that vary with time to indicate cues for the user holding the hand-hold terminal 2 to input menu items. The dynamic image and voice refers specifically to a shot animation showing the ordering of the customer and the like.

According to the dynamic image displayed on the LCD la and the voice regenerated by the loudspeaker 1c, the user touches the menu item button on the input interface image 11 to input the ordered menu item. Menu item input operation includes canceling an input menu item. Moreover, after inputting all the ordered menu items, the user touches the button ‘send’ 22a on the input interface image 22 to end the operation.

Here, in Acts Sa5 and Sa6, the CPU 1m waits for the input of menu items or an operation end. Further, if menu items are input, the CPU 1m proceeds to execute Act Sa7 from Act Sa5. In addition, the CPU 1m may proceed to execute Act Sa9 from Act Sa5 in the case where no ending operation is carried out before the regeneration ending moment of the dynamic image or a given period elapses from the regeneration ending moment of the dynamic image.

In Act Sa7, the CPU 1m updates the list of the ordered menu items according to the menu item input operation. That is, the CPU 1m updates the list of the ordered menu items to add corresponding menu items after inputting specified menu items. Moreover, the CPU 1m updates the list of the ordered menu items to delete corresponding menu items after certain menu items are cancelled.

In Act Sa8, the CPU 1m updates operation record information. In addition, the CPU 1m generates new operation record information when entering into Act Sa8 initially during the current training processing. Operation record information contains the operation information that is corresponding to the trainee and related to the operations of the trainee. Operation information at least indicates the content of an operation and a timing of the operation implementation moment. That is, for example, the operation information indicates which button on the input interface image 22 is pressed down and at which timing the pressing down is carried out. The CPU 1m stores the operation record information in the RAM 1j or the HDD 1k. Then, the CPU 1m returns to execute Acts Sa6 and Sa7 to be in a wait state.

If the operation is ended when the CPU 1m is in the wait state of Acts Sa5 and Sa6, then the CPU 1m proceeds to execute Act Sa9 from Act Sa6.

In Act Sa9, the CPU 1m determines whether or not all the menu items contained in the list of the ordered menu items are the same as those contained in the specified order menu items recorded in the training course database of the currently selected training course and if so, proceeds to execute Act Sa10 from Act Sa9.

In Act Sa10, the CPU 1m marks the completion flag that is contained in the training condition database of the user authenticated in Act Sa1 and related to the currently selected training course as ‘1’.

In Act Sa11, the CPU 1m calculates the degree of the training progress achieved by the user authenticated in Act Sa1. The degree of progress may be calculated according to any preset rule. For instance, the degree of progress may be calculated by calculating the number of the training courses with a completion flag ‘1’. In this case, if the training condition database is in the state shown in FIG. 4, then the degree of progress achieved by the user ‘shop assistant A’ is ‘4’. Or the degree of progress is calculated by calculating the product of a coefficient corresponding to the difficulty of a training course and the total number of completion flags. That is, in the case where coefficients of training courses ‘elementary’, ‘intermediate’, ‘senior’ and ‘ clothing’ are set to be ‘1’, ‘2 ’ , ‘3’ and ‘ 4’ according to the grades of the courses, if the training condition database is in the state shown in FIG. 4, then the degree of the progress achieved by the user ‘shop assistant A’ is changed to ‘5’.

In Act Sa12, the CPU 1m determines the skill of the user according to the degree of the progress and reflects the skill in the training condition database. Specifically, the correspondence relationship between the degree of progress and a skill level is preset. In addition, the skill level refers to such an index as ‘working junior’ or ‘working intermediate’ for measuring the skill of the user. Further, the CPU 1m makes no change in the training condition database if the degree of progress rises but the skill level is unchanged. However, the CPU 1m changes the record in the information field of the training condition database related to a skill level if the degree of progress reaches a new skill level. More specifically, if the user ‘shop assistant A’ completes the training course ‘two customers’ correctly, the CPU 1m determines the skill level of the user to be ‘working intermediate’. At this time, the CPU 1m updates the training condition database by changing, for example, the information field ‘working junior’ (shown in FIG. 4) related to the skill level of the information field ‘shop assistant A’ related to a user name to ‘working intermediate’.

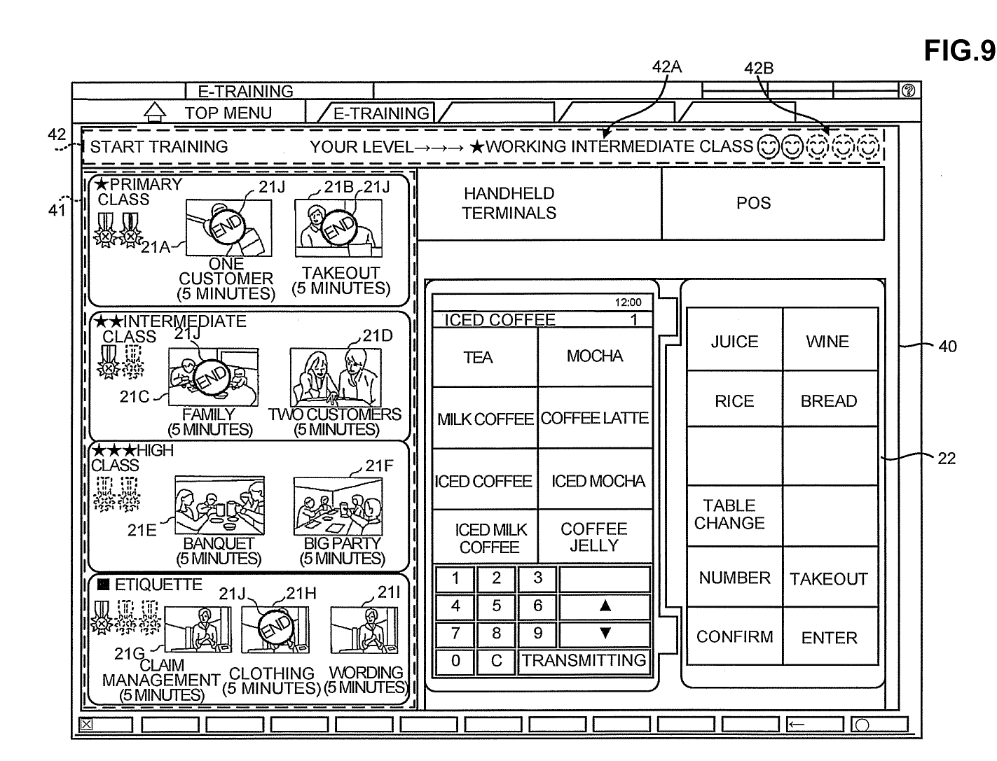

Then, the CPU 1m returns to execute Act Sa3 to display the course selection image again. At this time, the CPU 1m generates a course selection image according to the information recorded in the latest training condition database. Thus, if the training condition database is updated as, for example, in the specific example above, the image shown in FIG. 9 is shown again as a course selection image. In the course selection image 40 shown in FIG. 9, the course list image 41 is different from the course list image 21 by containing a completion flag 21j overlapped with the dynamic image thumbnail 21d. Moreover, in the course selection image 40, the guidance image 42 is different from the guidance image 23 by containing a string 42 representing the changed skill level and a mark 42b.

In Act Sa9, if it is determined that the menu items contained in the list of the ordered menu items are different from those contained in the specified order menu item recorded in the training course database of the currently selected training course, the CPU 1m returns to execute Act Sa2 from Act Sa9. In this case, as the training condition database is not updated, the course selection image 20 shown in FIG. 7 is displayed again.

As stated above, by using the method for training operating a hand-hold terminal 2 used in a restaurant for an order service, in which a dynamic image for the use of an order and an input interface image 22 (operation image) simulating the user interface of the user of the hand-hold terminal 2 are displayed in the information terminal 1, the operation image of the hand-hold terminal 2 is operated according to the dynamic image, a determination is made on whether or not to carry out an operation according to the dynamic image, and the result of the determination is displayed, the user can training operating the hand-hold terminal 2 without causing any trouble to the other people.

Moreover, the information terminal 1 calculates the degree of the consistence between the operation of the user and a preset operation and notifies the user of the calculated result by displaying the calculated result to the user. Therefore, the user can know from the notice whether or not an operation is correctly done.

Further, the information terminal 1 automatically determines whether or not the user operates correctly and shows the user the result of the determination based on the existence or absence of a completion flag 21j. Therefore, the user can determine whether or not a correct operation is carried out.

Further, the information terminal can show the user a skill level. Therefore, the user can easily and correctly know how familiar he/she is with the operation of the hand-hold terminal 2.

According to the training method, by using a structure which adds practicable trainings according to the progress achieved by the trainee or the number of the practicable courses, the trainee can training in stages based on his/her skill or experience.

After completing the training above, the user (trainee) or other people (e.g. guider) desire to confirm the training result by regenerating the training degree.

Therefore, the information terminal 1 provides a structure which shows a training result for the trainee by regenerating the training progress using the information terminal 1.

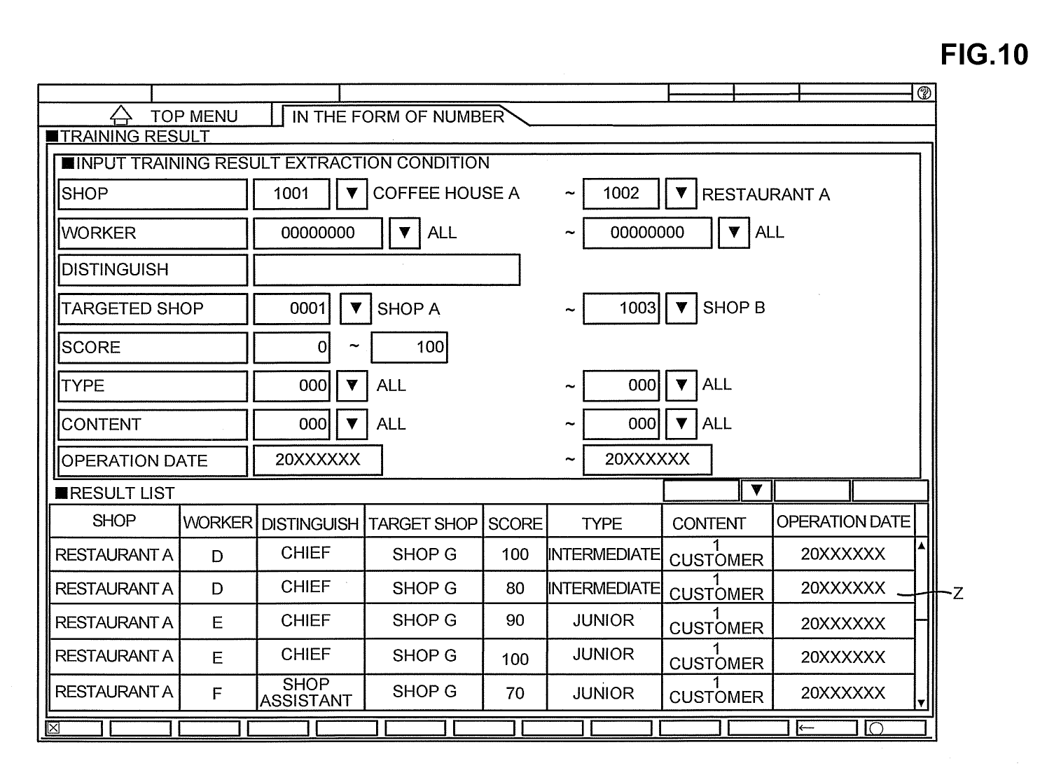

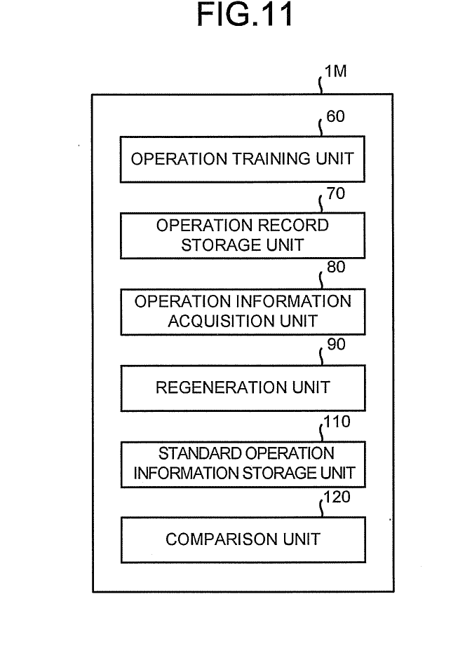

Specifically, the information terminal 1 displays, for example, the training result list Z that is shown in FIG. 10 as the result of the aforementioned training on the LCD 1a, enables the user (trainee) or other people (e.g. guide) to select a training related to the specified trainee from the training result list Z via the touch panel 1r, and confirm the training result according to the operation of the trainee during the regenerated training.

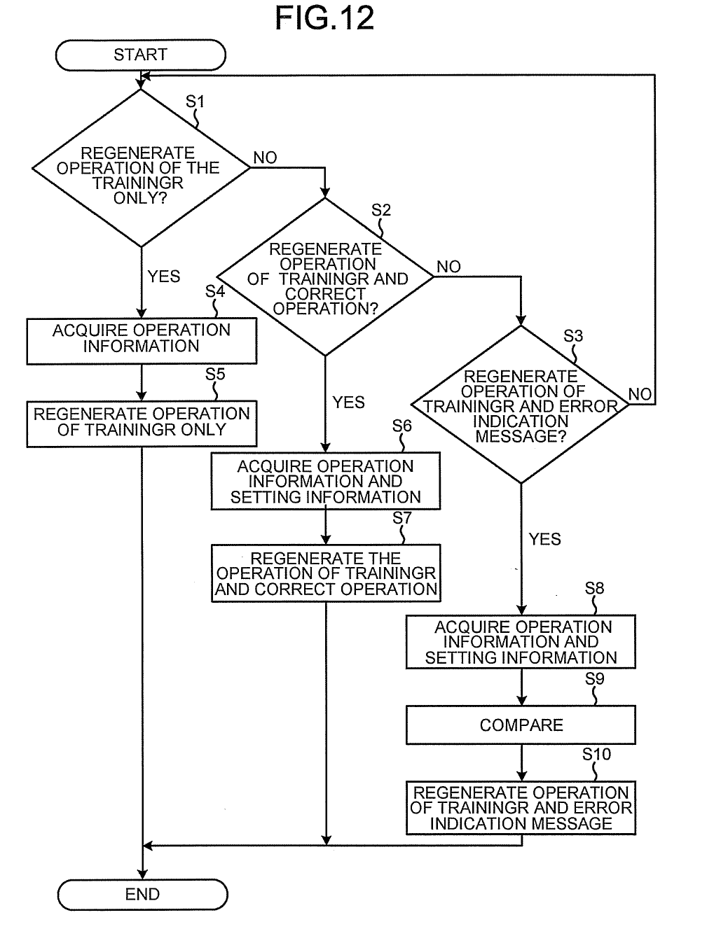

Here, FIG. 11 is a functional block diagram illustrating the functional structure for a training confirming processing. FIG. 12 is a flow chart of a training confirming process. The program executed in the CPU 1m of the information terminal 1 becomes a modular structure including the units (an operation training unit 60, an operation record storage unit 70, an operation information acquisition unit 80, a regeneration unit 90, a standard operation information storage unit 110 and a comparison unit 120) shown in FIG. 11; as a piece of actual hardware, the program is read from the ROM 1i or the HDD 1k by the CPU 1m and then executed to carry each of the aforementioned units on the RAM 1j and generate the operation training unit 60, the operation record storage unit 70, the operation information acquisition unit 80, the regeneration unit 90, the standard operation information storage unit 110 and the comparison unit 120 on the RAM 1i.

In addition, the operation training unit 60 operates the user interface according to the dynamic image shown together with the image simulating the user interface of the hand-hold terminal 2 for the use of an order, as described in the training processing shown in FIG. 6.

Further, as stated above, the operation record storage unit 70 stores the operation information at least indicating the content of an operation and a timing of the operation implementation moment in the RAM 1j or the HDD 1k as operation record information.

Further, as stated above, the standard operation information storage unit 110 stores the setting information containing the content of a standard operation that should be carried out by the user according to an opportunity phenomena represented by a dynamic image 31a for the user of an order in the HDD 1k as a standard operation setting file.

The following three methods are listed as the method for regenerating an operation condition during a training:

(1) regenerate the operation of the trainee only;

(2) regenerate the operation of the trainee and the correct operation;

(3) regenerate the operation of the trainee and an error indication message.

As shown in FIG. 12, when ‘regenerate the operation of the trainee only’ is selected (Act S1: Yes) through a mode switching using a button (not shown), the operation information acquisition unit 80 acquires the operation information (operation content and timing of the operation implementation moment) related to a specified trainee according to the operation record information stored in the RAM 1j or the HDD 1k (Act S4), and the regeneration unit 90 displays and regenerates, according to the operation information, which button on the input interface image 22 is pressed down during the training and at which moment the pressing down is carried out (Act S5). Specifically, at the timing of a matched operation button contained in the operation information, the operation button contained in the stored operation information is identified and displayed in such a way that a corresponding button on the input interface image 22 or another button can be identified.

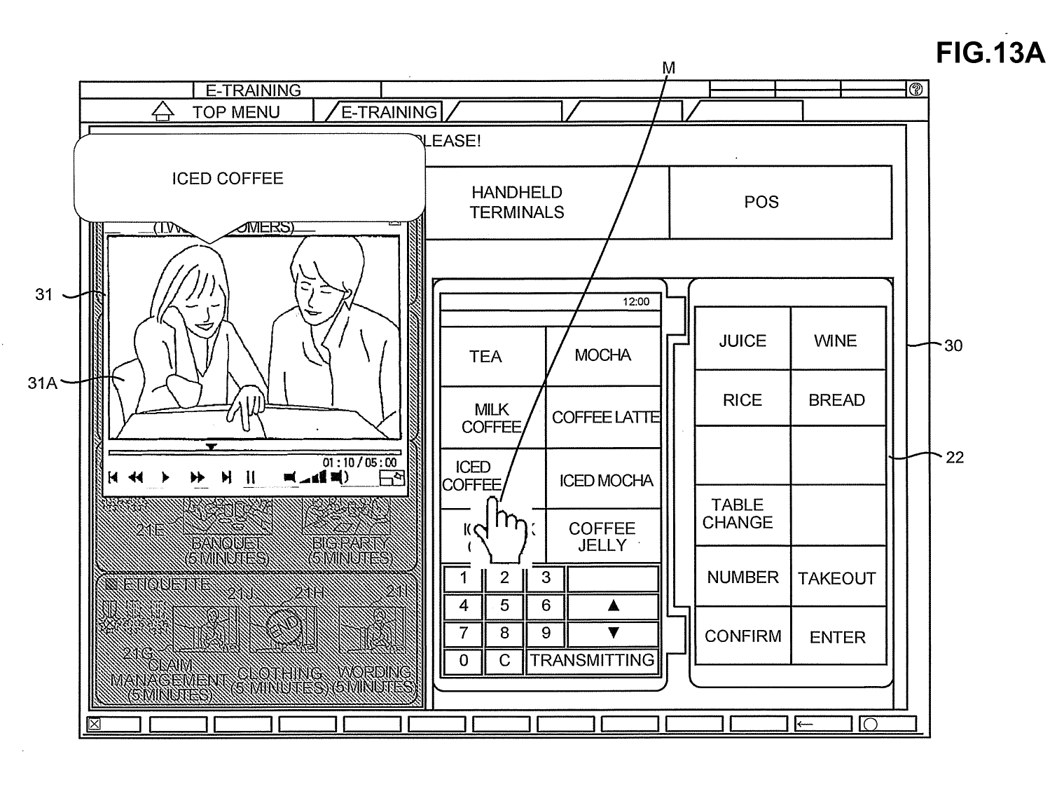

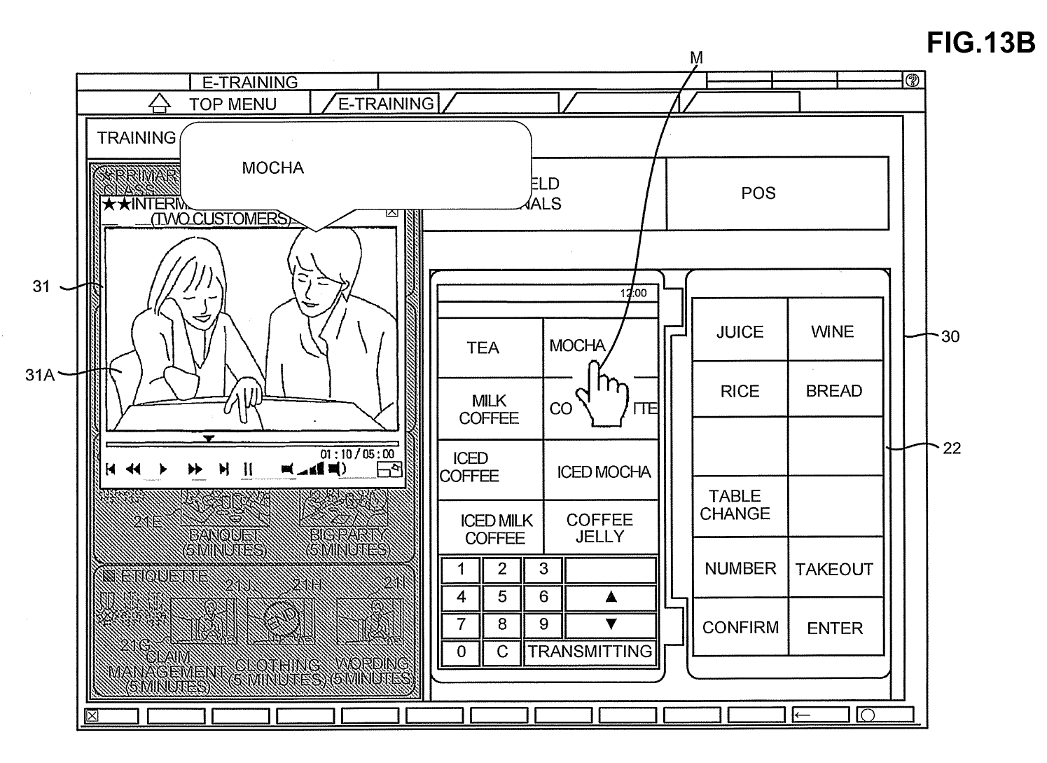

FIG. 13 is a front view illustrating an example of a display screen containing a regenerated training image. As shown in FIG. 13, a button corresponding to a training operation is identified by a finger mark M. FIG. 13 (a) shows, in the case where a training course titled ‘two customers’ is selected, a standard operation of pressing down the button ‘iced coffee’ for the dynamic image 31a showing a customer ordering a cup of iced coffee. FIG. 13(b) shows, in the case where a training course titled ‘two customers’ is selected, a standard operation of pressing down the button ‘mocha’ for the dynamic image of the other customer ordering a cup of mocha after a given time stored in the operation information elapses from the moment the button ‘iced coffee’ shown in FIG. 13 is pressed down.

As shown in FIG. 12, when ‘regenerate the operation of the trainee and the correct operation’ is selected (Act S2: Yes) through a mode switching using a button (not shown), the operation information acquisition unit 80 acquires the operation information (operation content and timing of the operation implementation moment) related to a specified trainee according to the operation record information stored in the RAM 1j or the HDD 1k (Act S6), and the regeneration unit 90 displays and regenerates, according to the operation information, which button on the input interface image 22 is pressed down during the training and at which moment the pressing down is carried out (Act S7). The specific display of the operation condition is the same as that described in Act S5. Moreover, the operation information acquisition unit 80 acquires, from the standard operation setting file stored in the HDD 1k, the setting information (operation order, button type and the like) of the standard operation that should be carried out by the user according to a cue represented by the dynamic image 31a during the training (Act S6), and the regeneration unit 90 explicitly displays and regenerates the correct operation by highlighting (for example, adding a red frame) the button in the input interface image 22 according to the setting information (Act S7).

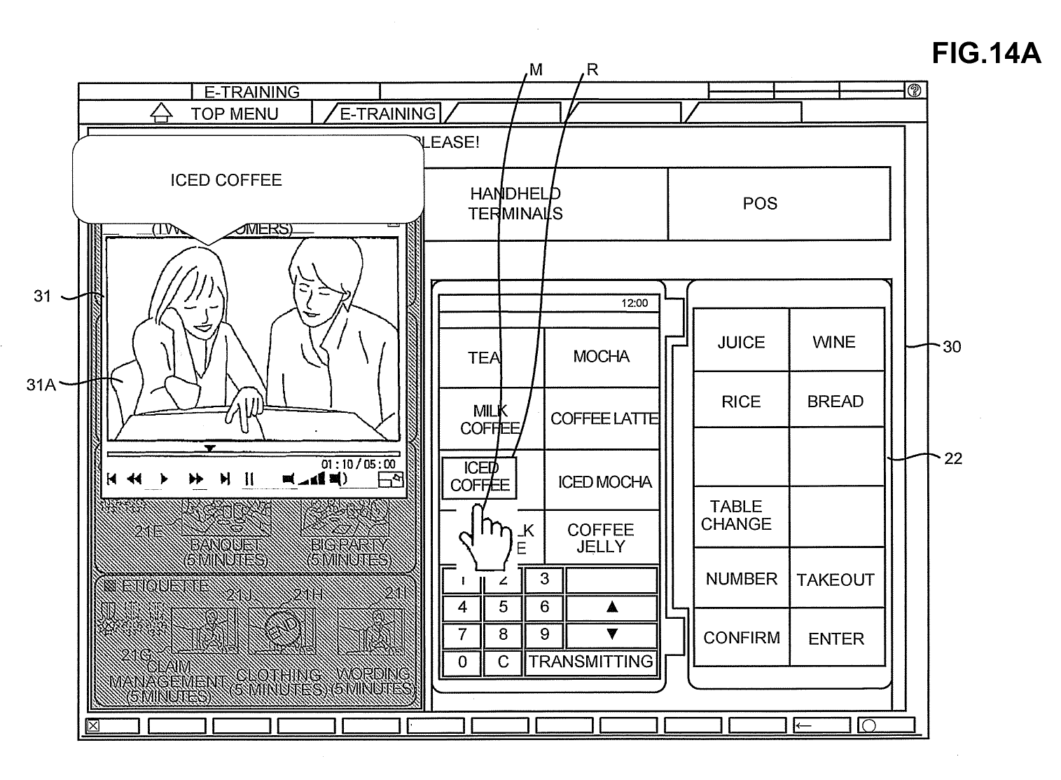

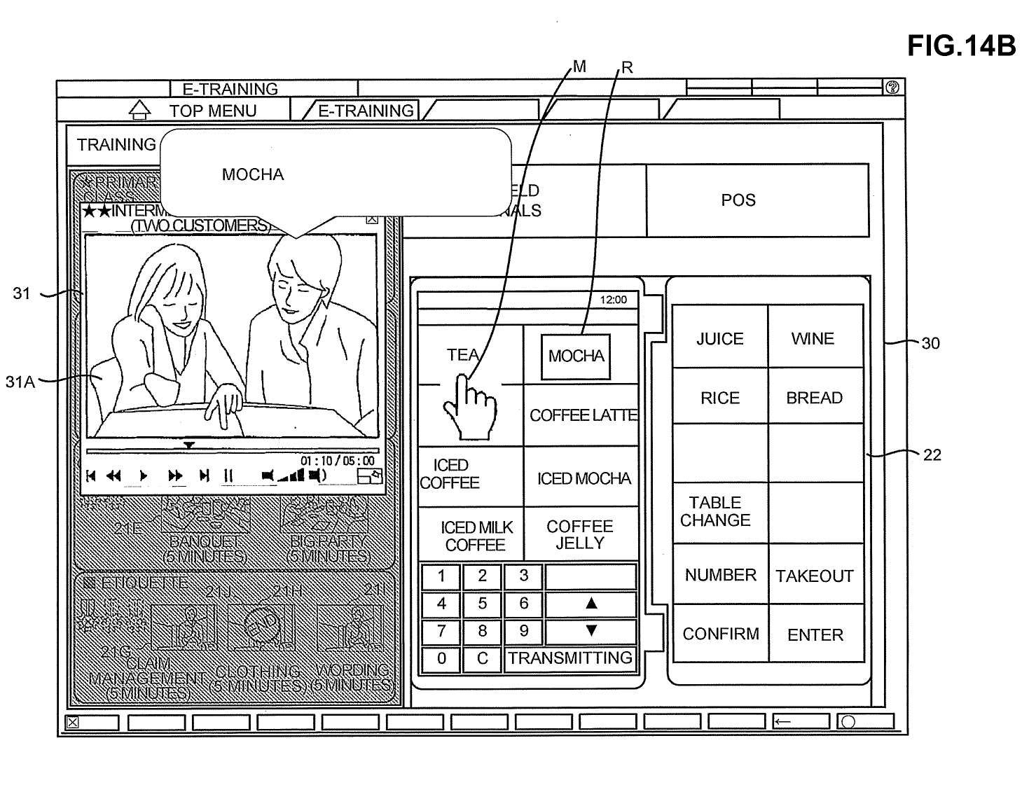

FIG. 14 is a front view illustrating an example of a display screen containing a regenerated training image. As shown in FIG. 14, a button corresponding to a training operation is identified by a finger mark M. FIG. 14a shows, in the case where a training course titled ‘two customers’ is selected, a standard operation of pressing down the button ‘iced coffee’ with a red frame for the dynamic image 31a showing a customer ordering a cup of iced coffee. FIG. 14b shows, in the case where a training course titled ‘two customers’ is selected, an error operation of pressing down the button ‘coffee’ for the dynamic image of the other customer ordering a cup of ‘iced coffee’ after a given time stored in the operation information elapses from the moment the button ‘iced coffee’ shown in FIG. 14a is pressed down. In addition, as shown in FIG. 14(b), the standard operation is pressing down the button ‘mocha’ with a red frame.

As shown in FIG. 12, when ‘regenerate the operation of the trainee and an error indication message’ is selected (Act S3: Yes) through a mode switching using a button (not shown), the operation information acquisition unit 80 acquires the operation information (operation content and timing of the operation implementation moment) related to a specified trainee according to the operation record information stored in the RAM 1j or the HDD 1k (Act S8), and the regeneration unit 90 displays and regenerates, according to the operation information, which button on the input interface image 22 is pressed down during the training and at which moment the pressing down is carried out (Act 10). The specific display of the operation condition is the same as that described in Act S5. Moreover, the operation information acquisition unit 80 acquires, from the standard operation setting file stored in the HDD 1k, the setting information (operation order, button type and the like) of the standard operation that should be carried out by the user according to a cue represented by the dynamic image 31a during the training (Act S8), and the regeneration unit 90 explicitly displays and regenerates the correct operation by highlighting (for example, adding a red frame) the button in the input interface image 22 according to the setting information (Act S10) Moreover, the comparison unit 120 compares the operation information related to the specified trainee with the setting information of the operation that should be carried out by the user (Act S9), and the regeneration unit 90 explicitly displays information ‘right’ or ‘wrong’ as a comparison result (Act S10).

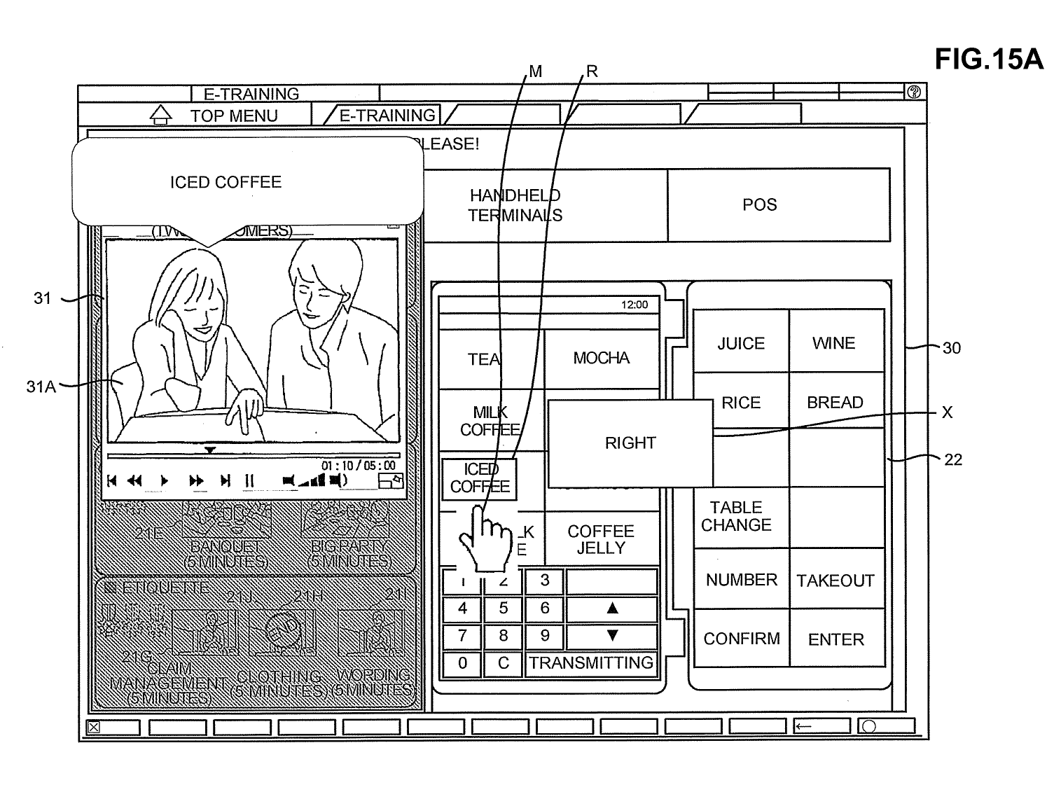

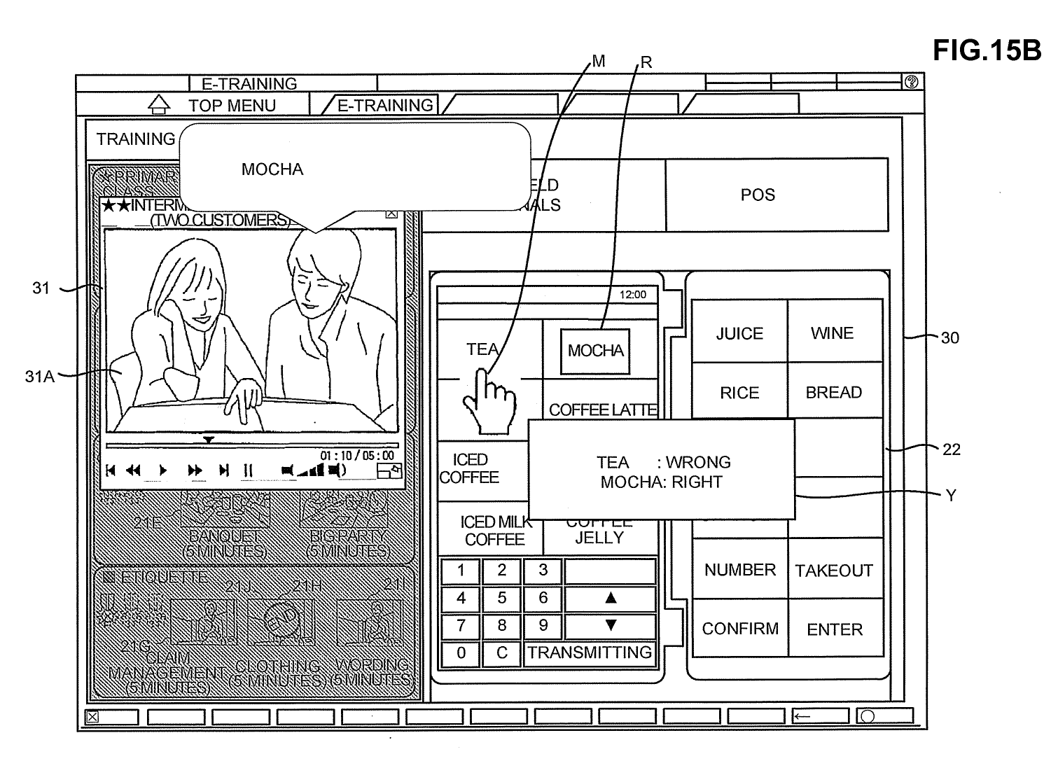

FIG. 15 is a front view illustrating an example of a display screen containing a regenerated training image. As shown in FIG. 15, a button corresponding to a training operation is identified by a finger mark M. FIG. 15a shows a standard operation of pressing down the button ‘iced coffee’ with a red frame R for the dynamic image 31a showing a customer ordering a cup of iced coffee in the case where a training course titled ‘two customers’ is selected. At this time, information X ‘right’ is displayed as the operation information related to the specified trainee is in accordance with the setting information of the operation that should be carried out by the user. FIG. 15b shows, in the case where a training course titled ‘two customers’ is selected, an error operation of pressing down the button ‘coffee’ for the dynamic image 31a showing the other customer ordering a cup of ‘mocha’ after a given time stored in the operation information elapses from the moment the button ‘iced coffee’ shown in FIG. 15a is pressed down. In addition, as shown in 15(b), the standard operation is pressing down the button ‘mocha’ with a red frame. At this time, information Y ‘‘coffee’ is right, but ‘mocha’ is wrong’ is displayed as the operation information related to the specified trainee is in accordance with the setting information of the operation that should be carried out by the user.

In this way, by using the order processing system provided in this embodiment, the user (trainee) or other people (e.g. guider) can confirm the training result by regenerating the training operation condition after completing the training.

This embodiment can have the following variations.

By comparing the menu items contained in the list of the ordered menu items with those in a specified order, the menu items that are missed in an input or input by mistake can be distinguished and then shown to the user in image.

The input interface image 22 can be replaced with the input interface image shown on the LCD 1a when the information terminal 1 serves as a POS terminal. Moreover, if the operation shown on the input interface image is input, the user can train operating the POS terminal.

The dynamic image can be replaced with a plurality of still images shown in the form of slide. That is, a plurality of still images can be automatically selected one by one at given time intervals as display objects and then displayed on the LCD 11a.

The information terminal 1 having the aforementioned training function may carry out other processing in addition to services including guide, order acceptation, serving (dish serving) and charging.

The operation of the user (the trainee) is not limited to the order input. In addition, the event serving as a cue for the operation a different operation of the user (the trainee) is different. Therefore, a dynamic or still image is shown that represents an opportunity phenomena corresponding to an operation of the user (the trainee). Moreover, the user interface image is also configured to respond to the operation of the user (the trainee).

The determination on a training result is not limited to the way of determining whether or not an input operation is completely accordant with a specified operation. For instance, a training result can be determined by determining the consistency between an input operation and a specified operation. Moreover, the training result can also be determined by adding such information as the order of input operations and the time for an input operation.

Or the actions above can be achieved by a training system comprising a terminal device and a server device. In this case, the user can train using one or more terminal devices with the same server device or a plurality of server devices.

Such training systems can be realized through a cloud calculation. More specifically, soft ware form which is called software as a service (SaaS) is good.

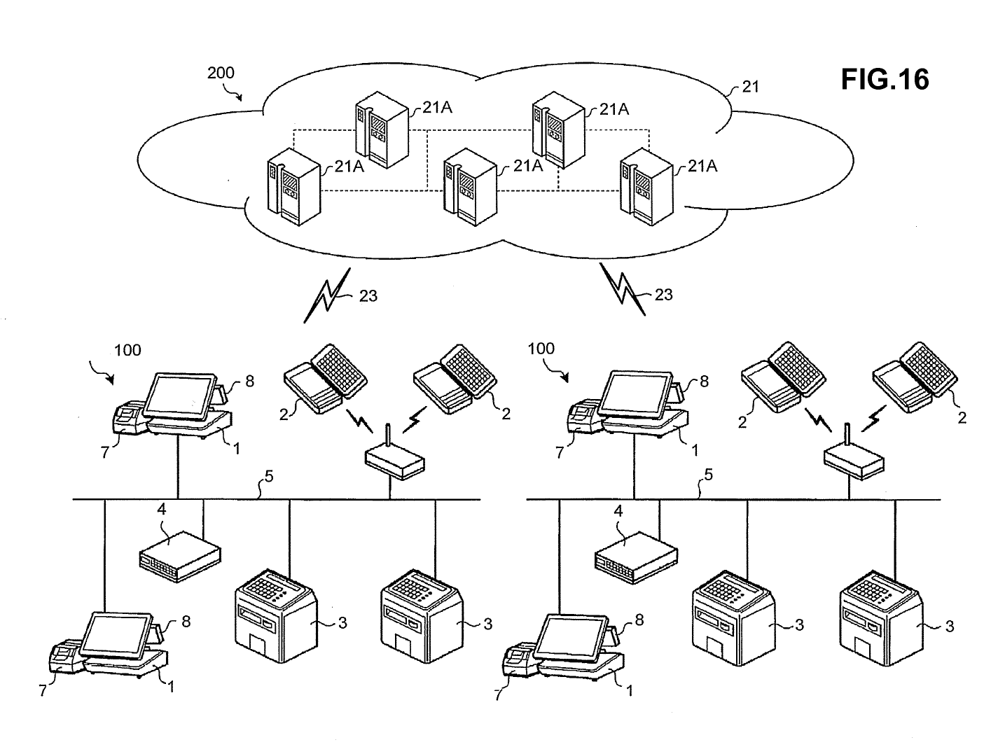

FIG. 16 is a diagram illustrating the structure of a training system 200 using a cloud system.

The training system 200 comprises a cloud 21, a plurality of order processing systems 100 and a plurality of communication networks 23. However, there may be one order processing system 100 and one communication network 23.

The cloud 21 further comprises a plurality of server devices 21a. which can communication with each other. However, it is allowed that there is only one server device 21a.

The information terminal 1 of the order processing system 100 may communicate with the cloud 21 via the communication network 23. In addition to various desktop or laptop Personal Computers (PC) or Points of Sales (POS), appropriate handsets, Personal Digital Assistants (PDA) or intelligent handsets can also serve as the information terminal 1. The communication network 23 may be the Internet, a private network, the next generation network (NGN) or a mobile network.

Moreover, the training system 200 uses the cloud 21 to execute the Act Sal shown in FIG. 6, and Acts Sa2-Sa12 and Acts Sb1-Sb10 shown in FIG. 12 can also be executed in either of the cloud 21 and the terminal device 100. However, the input of the authentication information used by the user authenticated in Act Sa1 can also be realized in the information terminal 1 of the order processing system 100.

The processing executed by the cloud 21 in Acts Sa1-Sa12 and Acts Sb1-Sb10 may also be executed in single server device 21a or a plurality of server devices 21a.

When the information terminal 1 in the order processing system 100 is used to execute at least one of Acts Sa2-Sa12 and Acts Sb1-Sb10, the program for enabling the computer in the information terminal 1 to execute the same processing may be pre-stored in the memory unit of the information terminal 1, or the program is stored in the memory unit of the cloud 21 and provided to the information terminal when needed. When the program is provided to the information terminal 1 from the cloud 21, at least one of the server devices 21a has a function of sending the program to the information terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training device, comprising:
a display unit configured to display an image simulating a user interface for inputting the operation to an input device, and a dynamic image or a still images displayed continuously which is represented an opportunity phenomena as the opportunity of the operation on one display;
an operation record storage unit configured to store an operation information which is input to the image simulating the user interface displayed on the display unit in a memory unit; and
a regeneration unit configured to display the operation information stored by the operation record storage unit on the display unit.

2. The training device according to claim 1, further comprising:
a standard operation information storage unit configured to store the setting information containing the standard operation information which is the content of a standard operation that should be carried out by the user according to the opportunity phenomena represented by the dynamic image or the still image in the memory unit; wherein
the regeneration unit displays the operation information with a correct operation based on the standard operation information on the image simulating the user interface according to the setting information.

3. The training device according to claim 2, further comprising:
a comparison unit configured to compare the operation information with the setting information; wherein
the regeneration unit displays the operation information and the correct operation based on the standard operation with the information of either correct or wrong as the comparing result by the comparison unit.

4. A method, comprising:
displaying an image simulating a user interface for inputting the operation to an input device, and a dynamic image or a still images displayed continuously which is represented an opportunity phenomena as the opportunity of the operation on one display;
storing an operation information which is input to the image simulating the user interface displayed on the display unit in a memory unit; and
displaying the operation information stored by the operation record storage unit on the display unit.

5. The method according to claim 1, further comprising:
storing the setting information containing the standard operation information which is the content of a standard operation that should be carried out by the user according to the opportunity phenomena represented by the dynamic image or the still image in the memory unit; and
displaying the operation information with a correct operation based on the standard operation information on the image simulating the user interface according to the setting information.

6. The method according to claim 2, further comprising:
comparing the operation information with the setting information; and
displaying the operation information and the correct operation based on the standard operation with the information of either correct or wrong as the comparing result by the comparison unit.

7. A training system contains at least one server device and at least one terminal device, comprising:
a display unit configured to display an image simulating a user interface for inputting the operation to an input device, and a dynamic image or a still images displayed continuously which is represented an opportunity phenomena as the opportunity of the operation on one display;
an operation record storage unit configured to store an operation information which is input to the image simulating the user interface displayed on the display unit in a memory unit; and
a regeneration unit configured to display the operation information stored by the operation record storage unit on the display unit; wherein
the server device comprises at least one of the operation record storage unit and the regeneration unit; and the terminal device comprises either the operation record storage unit or the regeneration unit which is not include in the server device.
